(19) United States
(12) Patent Application Publication
(10) Pub. No.: US 2026/0247479 A1
(43) Pub. Date: Aug. 20, 2026

(54) THROUGHPUT AND LATENCY ENHANCEMENT IN CELL DISCONTINUOUS TRANSMISSION OR RECEPTION

(71) Applicant: Apple Inc., Cupertino, CA (US)

(72) Inventors: Peng CHENG, Beijing (CN); Alexander SIROTKIN, Hod Hasharon (IL); Dan WU, Beijing (CN); Fangli XU, Beijing (CN); Haijing HU, Los Gatos, CA (US); Naveen Kumar R. PALLE VENKATA, San Diego, CA (US); Ping-Heng KUO, London (GB); Ralf ROSSBACH, Munich (DE); Sethuraman GURUMOORTHY, San Ramon, CA (US); Sigen YE, San Diego, CA (US); Yuqin CHEN, Beijing (CN); Zhibin WU, Los Altos, CA (US)

(21) Appl. No.: 19/471,981

(22) PCT Filed: Apr. 4, 2023
(86) PCT No.: PCT/CN2023/086132

§ 371 Date: Oct. 2, 2025

(51) Int. Cl. H04W 76/28; H04W 68/02; H04W 72/11; H04W 74/0833

(52) U.S. Cl. CPC H04W 76/28; H04W 68/02; H04W 72/11; H04W 74/0833

(57) ABSTRACT

A method performed by a UE is provided. The method includes determining a base station is in a non-active duration of a DTX/DRX cycle. The method includes determining a particular communication occasion within the non-active duration. The method includes determining a time window corresponding to the particular communication occasion based on configuration information. The method includes communicating with the base station within the time window. Another method performed by a UE is provided. The method includes determining a base station enters a non-active duration of a DTX/DRX cycle from an active duration of the DTX/DRX cycle. The method includes, in response to the determining, applying a LCH setting for communicating with the base station. The first LCH setting is different from a second LCH setting that is applied when the base station is in the active duration of the DTX/DRX cycle. Methods performed by a base station are also provided.

### TECHNICAL FIELD

The present disclosure generally relates to wireless communication, and in particular, to throughput and latency enhancement in cell discontinuous transmission or reception.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation (5G) New Radio (NR), among others. The wireless communication networks facilitate mobile broadband service using technologies such as orthogonal frequency-division multiplexing (OFDM), multiple input multiple output (MIMO), advanced channel coding, massive MIMO, beamforming, and/or other features.

Base station is a type of wireless access node in wireless communication networks that facilitate connection of user devices (e.g., user equipments, UEs) to the networks. Recent base stations have implemented a feature of discontinuous transmission or reception (DTX/DRX), which allows a base station to periodically enter a sleep mode and pause transmission and reception in order to save power. Each period of DTX/DRX is referred to as a DTX/DRX cycle. Each DTX/DRX cycle includes an active duration in which the base station actively performs transmission with one or more UEs, and a non-active duration in which the base station enters the sleep mode to save power.

### SUMMARY

In accordance with one aspect of the present disclosure, a method performed by a UE is provided. The method includes determining that a base station is in a non-active duration of a DTX/DRX cycle. The method includes determining a particular communication occasion within the non-active duration. The method includes determining a time window corresponding to the particular communication occasion based at least on configuration information. The method includes communicating with the base station within the time window.

In accordance with one aspect of the present disclosure, another method performed by a UE is provided. The method includes determining that a base station enters a non-active duration of a DTX/DRX cycle from an active duration of the DTX/DRX cycle. The method includes, in response to the determining, applying a first logical channel (LCH) setting for communicating with the base station. The first LCH setting is different from a second LCH setting that is applied when the base station is in the active duration of the DTX/DRX cycle.

In accordance with one aspect of the present disclosure, a method performed by a base station is provided. The method includes determining that the base station is in a non-active duration of a DTX/DRX cycle. The method includes communicating with a UE within a time window corresponding to a particular communication occasion within the non-active duration, wherein the time window is determined by the UE based at least on the particular communication occasion and configuration information.

In accordance with one aspect of the present disclosure, another method performed by a base station is provided. The method includes communicating, in an active duration of a DTX/DRX cycle, with a UE according to a first LCH setting applied by the UE. The method includes entering a non-active duration of the DTX/DRX cycle. The method includes determining that the UE has switched to a second LCH setting that is different from the first LCH setting. The method includes communicating, in the non-active duration of the DTX/DRX cycle, with the UE according to the second LCH setting.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIG. 2A illustrates an example timing diagram of a plurality of DTX/DRX cycles in which a base station performs discontinuous reception (DRX), according to some implementations.

FIG. 2B illustrates an example timing diagram of a plurality of DTX/DRX cycles in which a base station performs discontinuous transmission (DTX), according to some implementations.

FIGS. 3A, 3B, 4A and 4B illustrate example methods for throughput and latency enhancement in DRX or DTX, according to some implementations.

FIG. 5 illustrates an example UE, according to some implementations.

FIG. 6 illustrates an example access node, according to some implementations.

### DETAILED DESCRIPTION

A base station, such as a g-Node B (gNB) or an e-Node B (eNB), can operate in DTX/DRX cycles while in communication with a UE in a RRC_CONNECTED mode. These DTX/DRX cycles are referred to as Cell DTX/DRX cycles. The UE and the base station can exchange and process radio resource control (RRC) signaling and/or Layer One or Layer Two (L1/L2) signaling for the base station to activate or terminate DTX/DRX operations. Currently, when a base station operates in a non-active duration of a DTX/DRX cycle, the base station turns off communication with the UE except for signaling of a random access channel (RACH), paging (or synchronization signal block [SSBs]), or system information blocks (SIBs). While turning off such communication may lead to a gain of network energy saving (NES), it is possible that communication performance, such as Quality of Service (QoS), may be undermined. For example, turning off SR transmissions when the base station is in the non-active duration of the DTX/DRX cycle may cause the UE to overload the RACH.

This disclosure describes techniques to enhance communication between a base station and a UE while the base station is in Cell DTX/DRX cycles. As described below, in some implementations of the disclosed techniques, a UE is enabled to transmit scheduling requests (SRs) or transmitting physical uplink shared channel (PUSCH) signals according to configured grants (CGs) while the base station is in a non-active duration of DRX. Similarly, some implementations enable the UE to receive semi-persistent scheduling signals or monitor for dynamic scheduling signals while the base station is in a non-active duration of DTX. Furthermore, some implementations allow the base station to reduce wake-up time for SR or PUSCH receptions while in a non-active duration. By way of one or more features described below, implementations of this disclosure can improve the throughput and/or latency performance between the base station and the UE without significant adverse effect to NES gain.

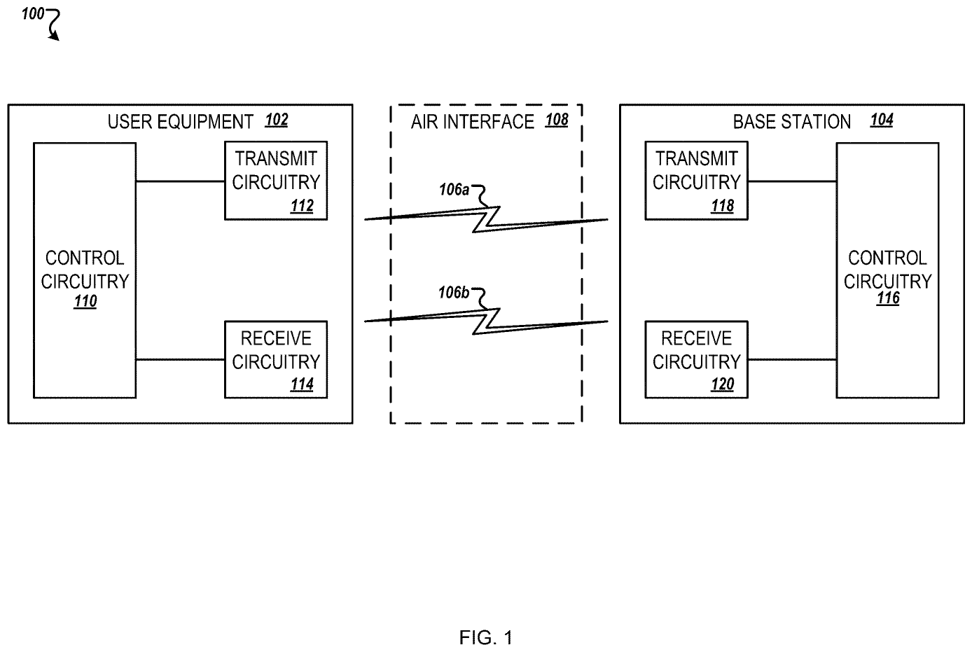

FIG. 1 illustrates an example wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates LTE and 5G NR communication standards as defined by the 3GPP technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and a Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, the control circuitry 110 can cause the UE 102 to enter or exit non-active durations and active durations in DTX/DRX cycles, and can control the transmit circuitry 112 and/or the receive circuitry 114 to schedule resources for the UE to transmit RACH signals, SRs, or CG-based PUSCH signals.

Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

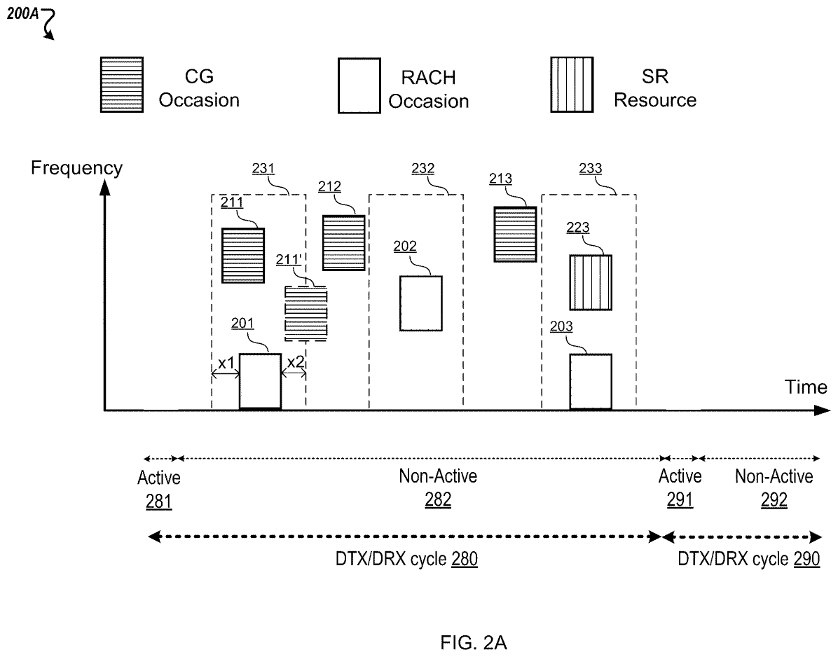

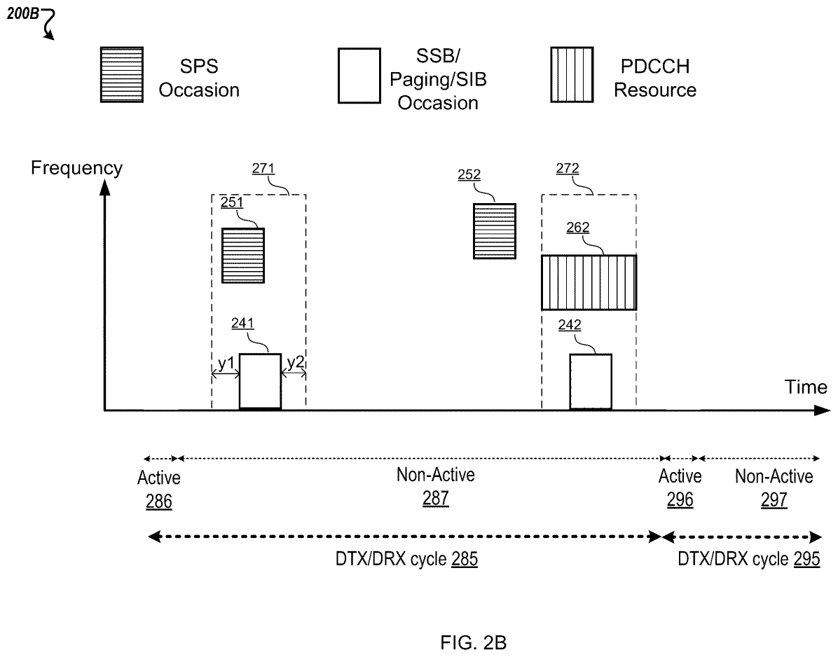

FIG. 2A illustrates an example timing diagram 200A of a plurality of DTX/DRX cycles in which a base station performs DRX, according to some implementations. Timing diagram 200A shows two consecutive DTX/DRX cycles 280 and 290, which can be Cell DTX/DRX cycles in which a base station, operate in communication with a UE. The below description of timing diagram 200A is based on an implementation in which the illustrated communication is between UE 102 and base station 104. As shown in timing diagram 200A, DTX/DRX cycle 280 has active duration 281 and non-active duration 282. DTX/DRX cycle 290 has active duration 291 and non-active duration 292. The horizontal axis of timing diagram 200A represents time, while the vertical axis of timing diagram 200A represents frequency.

Timing diagram 200A shows three RACH occasions (ROs) 201-203 configured to occur during non-active duration 282. At each of ROs 201-203, UE 102 can transmit a RACH signal to base station 104 even when base station 104 is non-active.

Timing diagram 200A also shows three CG occasions 211-213 configured to occur during non-active duration 282. At each of CG occasions 211-213, UE 102 has an opportunity to transmit a PUSCH signal to base station 104 if base station 104 is active. Additionally, timing diagram 200A shows a SR resource 223 that base station 104 allocates for UE 102. Using SR resource 223, UE 102 has an opportunity to transmit an SR to request transmission of uplink data if base station 104 is active.

To improve the throughput or latency performances of the communication between base station 104 and UE 102, some implementations allow UE 102 to utilize CG occasions and SR resources for uplink transmissions if certain timing and/or frequency conditions are met. When these conditions are met, base station 104 wakes up (e.g., turn on its receiver) to receive uplink transmissions from UE 102 even when base station 104 is still in a non-active duration of a DTX/DRX cycle. In some implementations, the conditions take into account whether the CG occasions and the SR resources in the time domain are close enough to the ROs (e.g., ROs 201-203). Because base station 104 expects to receive RACH signals at ROs 201-203, base station 104 wakes up for RACH signals even during non-active duration 282, and the NES gain already considers the power consumption from these RACH wake-ups. As such, if the CG occasions or the SR transmissions occur in a time period substantially contemporaneous to these RACH wakeups, base station 104 can receive the CG-based PUSCH transmissions or the SR transmissions during these RACH wakeups without separately designating wakeup time periods. Accordingly, base station 104 can advantageously use RACH wakeups to receive uplink transmissions from UE 102 without significantly increasing power consumption due to extra wakeups.

In some implementations, UE 102 uses a time window to determine whether a CG occasion or a SR time-domain resource is close enough to a RO. For example, ROs 201-203 corresponds to time windows 231-233, respectively. For CG occasions within time windows 231-233, UE 102 can perform PUSCH transmissions at these CG occasions. Similarly, for SR time-domain resources within time windows 231-233, UE 102 can perform SR transmissions using the SR time-domain resources. Base station 104 can configure UE 102 to obtain time windows for all CG occasions and SR resources in non-active duration 282 or for only a subset of CG occasions and SR resources in non-active duration 282.

UE 102 can use one or more offset values to determine the time window corresponding to a particular CG occasion or SR resource. Using RO 201 as an example, UE 102 can obtain an offset x1 measured from the beginning of RO 201 to determine the beginning of time window 231. Similarly, UE 102 can obtain, in addition to or instead of offset x1, an offset x2 measured from the end of RO 201 to determine the end of time window 231. In some implementations, x1 and x2 are equal, so UE 102 uses only the single offset for the determination. Offset values x1 and/or x2 can be provided by base station 104. In determining the time window corresponding to a RO with two-step RACH, UE 102 can treat the PUSCH transmission associated with the RACH as part of the RO (e.g., within the timing boundaries of the RO).

In timing diagram 200A, CG occasion 211 falls within time window 231. Accordingly, UE 102 can determine that CG occasion 211 occurs close enough to RO 201. Accordingly, UE 102 can transmit PUSCH data at CG occasion 211 contemporaneously with the RACH transmission at RO 201, without significantly increasing the wakeup time of base station 104. Conversely, CG occasions 212 and 213 do not fall within any time window. Accordingly, UE 102 can determine not to transmit PUSCH data at CG occasions 212 and 213. Following a similar determination, SR resource 223 falls within time window 233 corresponding to RO 203 in the time domain. Accordingly, UE 102 can determine that an SR can be transmitted using SR resource 223 contemporaneously with the RACH transmission at RO 203, without significantly increasing the wakeup time of base station 104.

Base station 104 can configure UE 102 whether to transmit a CG-based PUSCH signal or a SR, or both, if the CG and the SR resource both fall within the same time window. Base station 104 can also configure UE 102 as to whether to consider a CG occasion or SR resource that partially overlaps the time window as falling “within” the time window. For example, for CG occasion 211′ that partially overlaps time window 231, UE 102 can determine, based on a configuration from base station 104, whether to consider CG occasion 211′ as within time window 231 and whether to transmit PUSCH data at CG occasion 211′.

In some implementations, instead of or in addition to using time windows to select CG occasions and SR resources for uplink transmissions, UE 102 makes the selection according to a configuration from base station 104 without reference to the timing of ROs. For example, UE 102 can make the selection based on a list provided by base station 104 via RRC signaling, where the list provides the indices of the CG occasions and/or configurations of SR resources at which time base station 104 expects uplink transmissions. UE 102 can accordingly select the CG occasions and/or the SR resources according to the list. Alternatively or additionally, UE 102 can make the selection based on a time mask provided by base station 104 via RRC signaling, where the time mask specifies a time period within which base station 104 expects uplink transmissions. UE 102 can accordingly select the CG occasions and/or the SR resources that occur between a beginning and an end of the time mask. In these implementations, base station 104 takes measures to make sure the CG occasions and/or the SR resources indicated by the list or by the time mask are close enough to ROs such that uplink transmissions at these CG occasions or using these SR resources do not significantly reduce the NES gain.

In some implementations, UE 102 further determines a frequency resource for transmitting the CG-based PUSCH signal or the SR. For example, UE 102 can transmit the PUSCH signal or the SR using a frequency resource limited to an initially-configured (e.g., configured prior to DTX/DRX cycle 280) bandwidth part (BWP). Alternatively or additionally, UE 102 can transmit the PUSCH signal or the SR using a frequency resource that includes all BWPs that base station 104 uses in an active duration (e.g., active duration 281).

Base station 104 can configure UE 102 whether to allow retransmission following a CG-based PUSCH transmission. Depending on whether to allow retransmission, UE 102 can control one or more timers. For example, if retransmission is allowed, UE 102 can start HARQ-RTT-timer after the PUSCH transmission. After HARQ-RTT-timer expires, UE 102 can wake up to monitor a PDCCH for retransmission by starting HARQ-ReTX-timer. Conversely, if retransmission is not allowed, UE 102 can stop HARQ-RTT-timer or HARQ-ReTX-timer, if either is running. Alternatively or additionally, UE 102 can refrain from starting HARQ-RTT-timer.

As another example of retransmission configuration, if retransmission is not allowed, UE 102 can start a timer, such as a CellDRXInactivity timer, after a SR transmission. Before the timer expires, UE 102 can wake up to monitor a PDCCH for signaling from base station 104 relating to PDSCH receptions and/or PUSCH transmissions. After the timer expires, UE 102 can stop monitoring the PDCCH. To avoid retransmission, UE 102 can keep HARQ-RTT-timer and a HARQ-ReTX-timer off (e.g., not starting HARQ-RTT-timer and HARQ-ReTX-timer). Conversely, if retransmission is allowed, UE 102 can follow similar procedures as if retransmission is not allowed, except that UE can start HARQ-RTT-timer after transmitting a PUSCH signal. After HARQ-RTT-timer expires, UE can start HARQ-ReTX-timer and subsequently monitor the PDCCH.

In some implementations, after UE 102 determines that a CG occasion or a SR resource (e.g., CG occasion 211 or SR resource 223) can be used for uplink transmission during non-active duration 282, UE 102 uses that CG occasion or SR resource to request base station 104 to immediately enter an active duration (e.g., by aborting DTX/DRX cycles 280).

In some implementations, base station 104 performs DTX in addition to DRX while in non-active duration 282 of DTX/DRX cycle 280. For example, base station 104 can transmit semi-persistent scheduling (SPS) signals via a physical downlink shared channel (PDSCH) or dynamic scheduling signals via the PDCCH to UE 102 in the time windows corresponding to ROs. As such, the wakeup time of base station 104 can be more efficiently used without incurring significant increase in power consumption.

FIG. 2B illustrates an example timing diagram 200B of a plurality of DTX/DRX cycles in which a base station performs DTX, according to some implementations. Similar to timing diagram 200A, timing diagram 200B shows two consecutive DTX/DRX cycles 285 and 295, which can be Cell DTX/DRX cycles in which a base station, operate in communication with a UE. The below description of timing diagram 200B is based on an implementation in which that the illustrated communication is between UE 102 and base station 104. As shown in timing diagram 200B, DTX/DRX cycle 285 has active duration 286 and non-active duration 287. DTX/DRX cycle 295 has active duration 296 and non-active duration 297. The horizontal axis of timing diagram 200B represents time, while the vertical axis of timing diagram 200B represents frequency.

Timing diagram 200B shows two occasions 241 and 242 configured to occur during non-active duration 287. At occasions 241 and 242, UE 102 can receive SSBs, paging signals, or SIBs, even when base station 104 is non-active. Occasions 241 and 242 are hereinafter referred to as SSB/Paging/SIB occasions 241 and 242, respectively. At SSB/Paging/SIB occasions 241 and 242, base station 104 can wake up by turning on its transmitter to communicate with UE 102.

Timing diagram 200B also shows two SPS occasions 251 and 252 configured to occur during non-active duration 287. At each of SPS occasions 251 and 252, UE 102 has an opportunity to receive a SPS signal from base station 104 if base station 104 is active. Additionally, timing diagram 200B shows PDCCH resource 262 that UE 102 can monitor. UE 102 has an opportunity to receive a dynamic scheduling signal transmitted via PDCCH using the resources provided by PDCCH resource 262 if base station 104 is active.

To improve the throughput or latency performances of the communication between base station 104 and UE 102, some implementations allow UE 102 to utilize SPS occasions and PDCCH resources for downlink receptions if certain timing and/or frequency conditions are met. When these conditions are met, base station 104 wakes up (e.g., turns on its transmitter) to transmit downlink signals to UE 102 even when base station 104 is in a non-active duration. In some implementations, the timing and/or frequency conditions take into account whether the SPS occasions and the PDCCH resources in the time domain are close enough to the SSB/Paging/SIB occasions (e.g., SSB/Paging/SIB occasions 241 and 242) such that base station 104 can efficiently utilize the RACH wakeups at SSB/Paging/SIB occasions 241 and 242 for downlink transmissions without significantly increasing power consumption.

Similar to the conditions described above with reference to timing diagram 200A where base station 104 performs DRX, the conditions for downlink transmissions for SPS and dynamic scheduling when base station 104 performs DTX while being non-active can include determining whether the SPS occasions and the PDCCH resources fall within a time window corresponding to each SSB/Paging/SIB occasion. For example, in timing diagram 200B, time windows 271 and 272 correspond to SSB/Paging/SIB occasions 241 and 242, respectively. UE 102 can receive a SPS signal from base station 104 at SPS occasion 251, which falls within time window 271, but cannot receive a SPS signal from base station 104 at SPS occasion 252, which does not fall within any time window. Likewise, UE 102 can monitor PDCCH resource 262 for a dynamic scheduling signal during time window 272. Base station 104 can communicate with UE 102 in advance of the downlink transmissions whether a SSB, a paging signal, or a SIB will be used in the downlink transmissions.

Similar to the time window determination in timing diagram 200A, UE 102 can determine each time window in timing diagram 200B using one or more offset values (e.g., y1 and y2), which are respectively measured from the beginning and the end of a corresponding SSB/Paging/SIB occasion. UE 102 can also be configured by base station 104 whether to consider a SPS occasion or a PDCCH resource that partially overlaps the time window as falling “within” the time window.

In some implementations, instead of or in addition to using time windows to select SPS and PDCCH resources for downlink receptions, UE 102 makes the selection according to a configuration from base station 104 without reference to the timing of SSB/Paging/SIB occasions. For example, UE 102 can make the selection based on a list provided by base station 104 via RRC signaling, where the list provides the indices of the SPS occasions and/or PDCCH resources at which time base station 104 performs downlink transmissions. UE 102 can accordingly select the SPS occasions and/or the PDCCH resources according to the list. Alternatively or additionally, UE 102 can make the selection based on a time mask provided by base station 104 via RRC signaling, where the time mask specifies a time period within which base station 104 performs downlink transmissions. UE 102 can accordingly select the SPS occasions and/or the PDCCH resources that occur between a beginning and an end of the time mask. In these implementations, base station 104 takes measures to make sure the SPS occasions and/or the PDCCH resources indicated by the list or by the time mask are close enough to SSB/Paging/SIB occasions such that downlink transmissions at these SPS occasions or using these PDCCH resources do not significantly reduce the NES gain.

In some implementations, UE 102 and base station 104 further determine a frequency resource for transmitting the SPS signal or the dynamic scheduling signal. For example, base station 104 can transmit the SPS signal or the dynamic scheduling signal using a frequency resource limited to an initially-configured (e.g., configured prior to DTX/DRX cycle 285) bandwidth part (BWP). Alternatively or additionally, base station 104 can transmit the SPS signal or the dynamic scheduling signal using a frequency resource that includes all BWPs that base station 104 uses in an active duration (e.g., active duration 286).

Base station 104 can configure UE 102 whether to allow retransmission following a SPS transmission via the PUSCH. Depending on whether to allow retransmission, UE 102 can control one or more timers. For example, if retransmission is allowed, UE 102 can start HARQ-RTT-timer after the PUSCH transmission. After HARQ-RTT-timer expires, UE 102 can wake up to monitor a PDCCH for retransmission by starting HARQ-ReTX-timer. Conversely, if retransmission is not allowed, UE 102 can stop HARQ-RTT-timer or HARQ-ReTX-timer, if either is running. Alternatively or additionally, UE 102 can refrain from starting HARQ-RTT-timer. In addition to controlling the timers, UE 102 can send a hybrid automatic repeat request (HARQ) acknowledgement (ACK) or a HARQ non-acknowledgement (NACK) to base station 104 even if base station 104 is non-active.

In some implementations, for a SPS occasion or a PDCCH resource (e.g., SPS occasion 251 or PDCCH resource 262) that can be used for downlink reception during non-active duration 287, base station 104 can further utilize these wakeup times to notify UE 102 that base station 104 is about to enter an active duration (e.g., by aborting DTX/DRX cycles 285). The notification can be via RRC signaling or via a downlink control information (DCI) signal. When base station 104 is in RRC_CONNECTED mode with multiple UEs in multiple cells, the DCI signal can be common to all cells (e.g., simultaneously sent to all UEs in communication with base station 104).

In scenarios where base station 104 is in in RRC_CONNECTED mode with multiple UEs in multiple cells, base station 104 can perform DRX and/or DTX in accordance with timing diagrams 200A and 200B on a per-serving cell basis. For example, base station 104, while being non-active in DRX, can provide a first connected UE with configurations for determining time windows around CGs, and provide a second connected UE with different configurations for determining a time mask.

To reduce power consumption while base station 104 is in a non-active duration of a DTX/DRX cycle, UE 102 can apply one or more LCH settings to reduce the wakeup time of base station 104. These LCH settings can be applied separate from the operations described with reference to timing diagrams 200A and 200B or can be applied in addition to those operations.

A first example of the LCH settings relates to a LCH prioritization (LCP) restriction, which can be applied to limit a variety of parameters in the communication between UE 102 and base station 104. These parameters include, e.g., supported numerologies, maximum PUSCH duration, types of CGs, supported serving cells, supported CGs, supported physical (PHY) priority, or supported HARQ modes. While UE 102 can apply less stringent LCP restrictions on the number and/or types of CGs while base station 104 is active, UE 102 can be configured to apply a different and more stringent LCP restriction on CGs while base station 104 is non-active. For example, UE 102 can apply a LCP restriction that supports communication at any of three CGs while base station 104 is active in DRX. Upon detecting that base station 104 becomes non-active in DRX, UE 102 can autonomously switch to a more stringent LCP restriction that support communication at only one of the three CGs and excludes the other two CGs. As such, base station 104 does not need to wake up and monitor the two excluded CGs for possible uplink transmissions. This can save power at base station 104.

A second example of the LCH settings relates to a mapping from LCHs to SR resource configurations, which can designate certain SR resource configurations for scheduling uplink data transmission from certain LCHs. For example, UE 102 can be configured to map the LCHs to multiple SR resource configurations while base station 104 is active in DRX. Upon detecting that base station 104 becomes non-active in DRX, UE 102 can switch to a more stringent setting that maps all LCHs to one single SR resource configuration. As such, base station 104 does not need to monitor the non-mapped SR resource configurations for possible uplink transmissions. This can save power at base station 104.

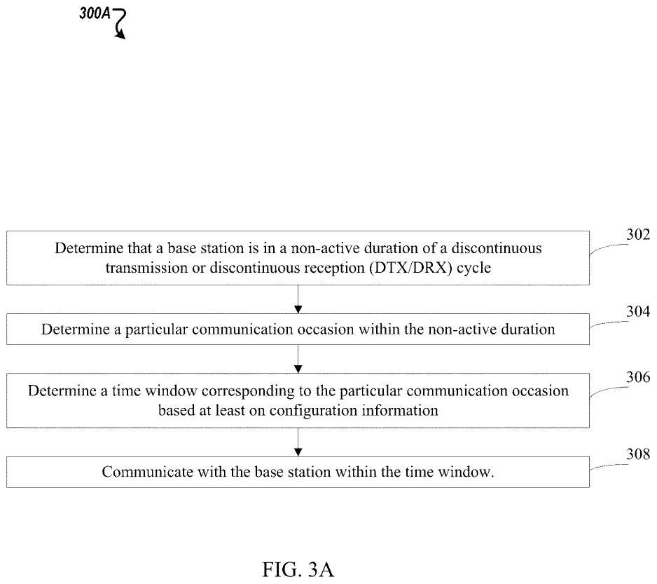

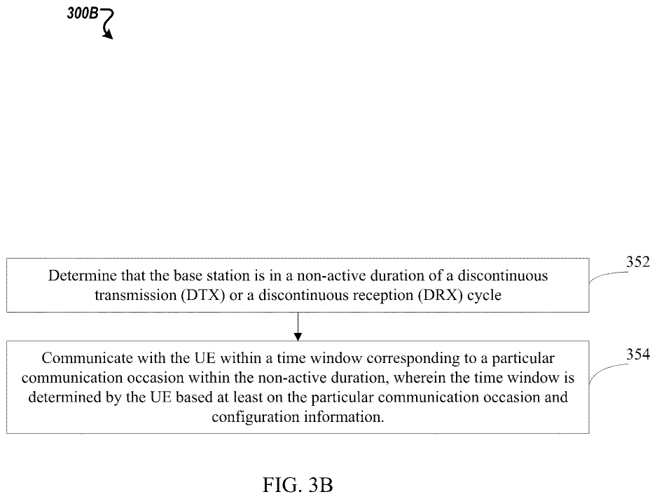

FIG. 3A illustrates an example method 300A for throughput and latency enhancement in DRX or DTX, according to some implementations. For clarity of presentation, the description that follows generally describes method 300A in the context of the other figures in this description. For example, method 300A can be performed by UE 102 of FIG. 1. It will be understood that method 300A can be performed, for example, by any suitable system, environment, software, hardware, or a combination of systems, environments, software, and hardware, as appropriate. In some implementations, various steps of method 300A can be run in parallel, in combination, in loops, or in any order.

At 302, method 300A involves determining that a base station is in a non-active duration of a DTX/DRX cycle, such as non-active duration 282 of DTX/DRX cycle 280 or non-active duration 287 of DTX/DRX cycle 285.

At 304, method 300A involves determining a particular communication occasion within the non-active duration. The particular communication occasion can be, e.g., RO 201 or 203 or SSB/Paging/SIB occasion 241 or 242.

At 306, method 300A involves determining a time window corresponding to the particular communication occasion based at least on configuration information. The time window can be, e.g., time window 231, 233, 271, or 272.

At 308, method 300A involves communicating with the base station within the time window. The communication can be, e.g., a PUSCH transmission at CG occasion 211, a SR transmission using SR resource 223, PDSCH reception at SPS occasion 251, or monitoring for dynamic scheduling signals using PDCCH resource 262.

FIG. 3B illustrates an example method 300B for throughput and latency enhancement in DRX or DTX, according to some implementations. For clarity of presentation, the description that follows generally describes method 300B in the context of the other figures in this description. For example, method 300B can be performed by base station 104 of FIG. 1. It will be understood that method 300B can be performed, for example, by any suitable system, environment, software, hardware, or a combination of systems, environments, software, and hardware, as appropriate. In some implementations, various steps of method 300B can be run in parallel, in combination, in loops, or in any order.

At 352, method 300B involves determining that the base station is in a non-active duration of a DTX/DRX cycle, such as non-active duration 282 of DTX/DRX cycle 280 or non-active duration 287 of DTX/DRX cycle 285.

At 354, method 300B involves communicating with the UE within a time window corresponding to a particular communication occasion within the non-active duration. The time window can be determined by the UE based at least on the particular communication occasion and configuration information. The particular communication occasion can be, e.g., RO 201 or 203 or SSB/Paging/SIB occasion 241 or 242.

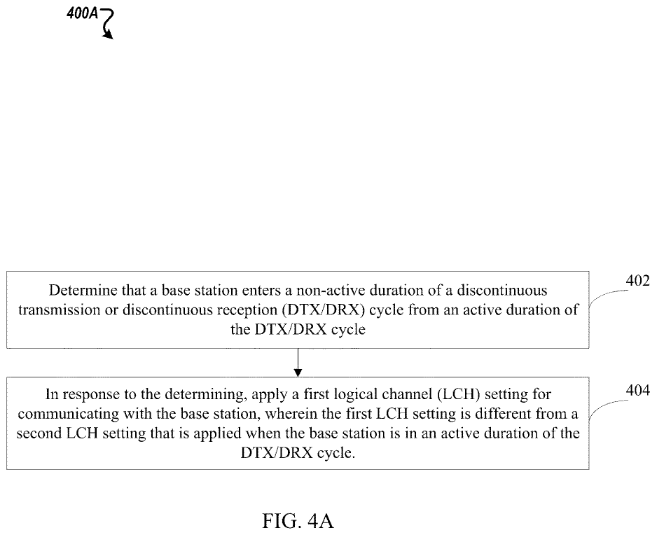

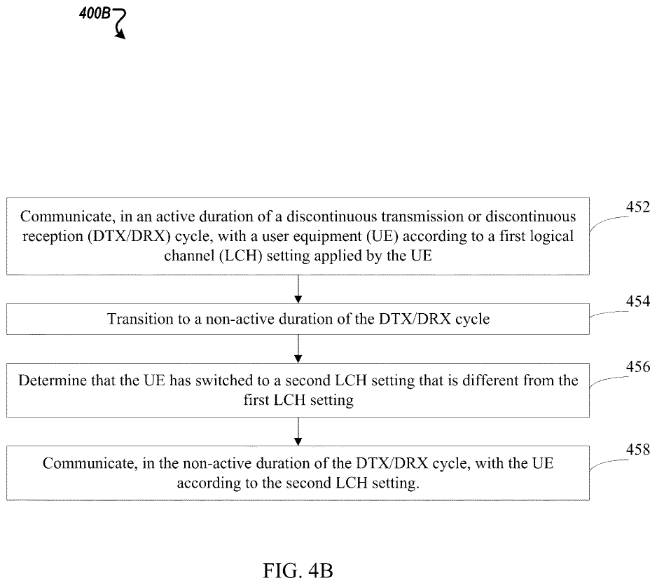

FIG. 4A illustrates an example method 400A for throughput and latency enhancement in DRX or DTX, according to some implementations. For clarity of presentation, the description that follows generally describes method 400A in the context of the other figures in this description. For example, method 400A can be performed by UE 102 of FIG. 1. It will be understood that method 400A can be performed, for example, by any suitable system, environment, software, hardware, or a combination of systems, environments, software, and hardware, as appropriate. In some implementations, various steps of method 400A can be run in parallel, in combination, in loops, or in any order.

At 402, method 400A involves determining that a base station enters a non-active duration of a DTX/DRX cycle from an active duration of the DTX/DRX cycle. The entry can be, e.g., from active duration 281 to non-active duration 282 of DTX/DRX cycle 280, or from active duration 286 to non-active duration 287 of DTX/DRX cycle 285.

At 404, method 400A involves applying a first LCH setting for communicating with the base station in response to the determination. The first LCH setting is different from a second LCH setting that is applied when the base station is in the active duration of the DTX/DRX cycle.

FIG. 4B illustrates an example method 400B for throughput and latency enhancement in DRX or DTX, according to some implementations. For clarity of presentation, the description that follows generally describes method 400B in the context of the other figures in this description. For example, method 400B can be performed by base station 104 of FIG. 1. It will be understood that method 400B can be performed, for example, by any suitable system, environment, software, hardware, or a combination of systems, environments, software, and hardware, as appropriate. In some implementations, various steps of method 400B can be run in parallel, in combination, in loops, or in any order.

At 452, method 400B involves communicating, in an active duration of a DTX/DRX cycle, with a UE according to a first LCH setting applied by the UE. The active duration can be, e.g., active duration 281 of DTX/DRX cycle 280 or active duration 286 of DTX/DRX cycle 285.

At 454, method 400B involves entering a non-active duration of the DTX/DRX cycle. The non-active duration can be, e.g., non-active duration 282 of DTX/DRX cycle 280 or non-active duration 287 of DTX/DRX cycle 285.

At 456, method 400B involves determining that the UE has switched to a second LCH setting that is different from the first LCH setting.

At 458, method 400B involves communicating, in the non-active duration of the DTX/DRX cycle, with the UE according to the second LCH setting.

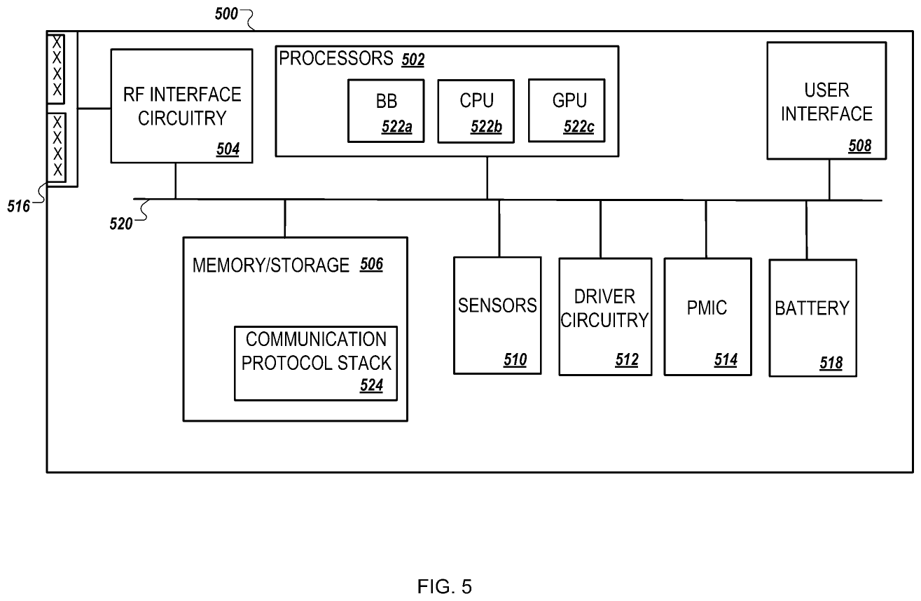

FIG. 5 illustrates an example UE 500, according to some implementations. The UE 500 may be similar to and substantially interchangeable with UE 102 of FIG. 1.

The UE 500 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 500 may include processors 502, RF interface circuitry 504, memory/storage 506, user interface 508, sensors 510, driver circuitry 512, power management integrated circuit (PMIC) 514, antenna structure 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc. that allows various circuit components (on common or different chips or chipsets) to interact with one another.

The processors 502 may include processor circuitry such as, for example, baseband processor circuitry (BB) 522A, central processor unit circuitry (CPU) 522B, and graphics processor unit circuitry (GPU) 522C. The processors 502 may include any type of circuitry or processor circuitry that executes or otherwise operates computer-executable instructions, such as program code, software modules, or functional processes from memory/storage 506 to cause the UE 500 to perform operations as described herein.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by one or more of the processors 502 to cause the UE 500 to perform various operations described herein. The memory/storage 506 include any type of volatile or non-volatile memory that may be distributed throughout the UE 500. In some implementations, some of the memory/storage 506 may be located on the processors 502 themselves (for example, L1 and L2 cache), while other memory/storage 506 is external to the processors 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 516 and proceed to filter and amplify (with a low-noise amplifier) the signal. The signal may be provided to a receiver of the transceiver that downconverts the RF signal into a baseband signal that is provided to the baseband processor of the processors 502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 516. In various implementations, the RF interface circuitry 504 may be configured to transmit/receive signals in a manner compatible with NR access technologies.

The antenna 516 may include antenna elements to convert electrical signals into radio waves to travel through the air and to convert received radio waves into electrical signals. The antenna elements may be arranged into one or more antenna panels. The antenna 516 may have antenna panels that are omnidirectional, directional, or a combination thereof to enable beamforming and multiple input, multiple output communications. The antenna 516 may include microstrip antennas, printed antennas fabricated on the surface of one or more printed circuit boards, patch antennas, phased array antennas, etc. The antenna 516 may have one or more panels designed for specific frequency bands including bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensor circuitry 528 and control and allow access to sensor circuitry 528, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processors 502, the PMIC 514 may control power-source selection, voltage scaling, battery charging, or DC-to-DC conversion.

In some implementations, the PMIC 514 may control, or otherwise be part of, various power saving mechanisms of the UE 500. A battery 518 may power the UE 500, although in some examples the UE 500 may be mounted deployed in a fixed location, and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

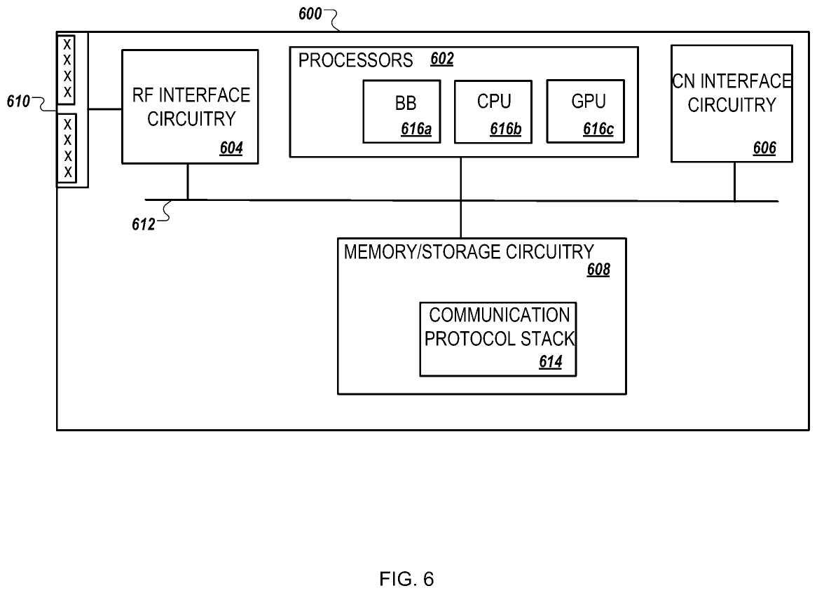

FIG. 6 illustrates an example access node 600 (e.g., a base station or gNB), according to some implementations. The access node 600 may be similar to and substantially interchangeable with base station 104. The access node 600 may include processors 602, RF interface circuitry 604, core network (CN) interface circuitry 606, memory/storage circuitry 608, and antenna structure 610.

The components of the access node 600 may be coupled with various other components over one or more interconnects 612. The processors 602, RF interface circuitry 604, memory/storage circuitry 608 (including communication protocol stack 614), antenna structure 610, and interconnects 612 may be similar to like-named elements shown and described with respect to FIG. 5. For example, the processors 602 may include processor circuitry such as, for example, baseband processor circuitry (BB) 616A, CPU 616B, and GPU 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In V2X scenarios, the access node 600 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary implementations are provided.

Example 1 includes a method performed by a user equipment (UE), the method including: determining that a base station is in a non-active duration of a discontinuous transmission or discontinuous reception (DTX/DRX) cycle; determining a particular communication occasion within the non-active duration; determining a time window corresponding to the particular communication occasion based at least on configuration information; and communicating with the base station within the time window.

Example 2 may include the method of Example 1, wherein the base station performs discontinuous reception in the non-active duration of the DTX/DRX cycle, and the particular communication occasion includes a random access channel (RACH) occasion (RO).

Example 3 may include the method of Example 2, wherein the RO includes an associated physical uplink shared channel (PUSCH).

Example 4 may include the method of Example 1, wherein the base station performs discontinuous transmission in the non-active duration of the DTX/DRX cycle, and wherein the particular communication occasion includes at least one of: a paging occasion (PO), a synchronization signal block (SSB) occasion, or a system information block (SIB) broadcast occasion.

Example 5 may include the method of any of Examples 1-4, wherein determining the particular communication occasion within the non-active duration includes: receiving, from the base station, a list of occasion configurations within the non-active duration; and determining the particular communication occasion from the list.

Example 6 may include the method of Example 5, wherein the list of occasion configurations includes at least one of: a list of configured grant (CG) configurations, a list of semi-persistent scheduling (SPS) configurations, or a list of scheduling request (SR) configurations.

Example 7 may include the method of any of Examples 1-4, wherein the configuration information includes a time mask, and wherein the particular communication occasion occurs between a beginning and an end of the time mask

Example 8 may include the method of any of Examples 1-7, wherein the configuration information includes at least one of a time offset measured from a starting time boundary of the particular communication occasion, or a time offset measured from an ending time boundary of the particular communication occasion.

Example 9 may include the method of any of Examples 1-8, wherein the configuration information indicates that the time window fully or partially overlaps the particular communication occasion.

Example 10 may include the method of any of Examples 1-9, wherein communicating with the base station within the time window includes at least one of: transmitting a scheduling request (SR), or transmitting an uplink signal according to a configured grant (CG).

Example 11 may include the method of Example 10, wherein communicating with the base station within the time window includes: transmitting the SR or the uplink signal using a frequency resource based on an initial bandwidth part (BWP).

Example 12 may include the method of Example 10, wherein communicating with the base station within the time window includes: transmitting the SR or the uplink signal using a frequency resource based on one or more bandwidth parts (BWPs) that the base station uses in an active duration of the DTX/DRX cycle.

Example 13 may include the method of Example 10, wherein communicating with the base station within the time window includes transmitting the uplink signal according to the CG, the method further including: determining a configuration for retransmission; and controlling at least one timer based on the configuration for retransmission.

Example 14 may include the method of Example 13, wherein the configuration for retransmission indicates that retransmission of the uplink signal according to the CG is not allowed, and wherein controlling the at least one timer based on the configuration for retransmission includes: starting a first timer after transmitting the uplink signal to the base station; monitoring a physical downlink control channel (PDCCH) after the first timer starts and before the first timer expires; and keeping a HARQ-RTT-timer and a HARQ-ReTX-timer off.

Example 15 may include the method of Example 13, wherein the configuration for retransmission indicates that retransmission of the uplink signal according to the CG is allowed, and wherein controlling the at least one timer based on the configuration for retransmission includes: starting a first timer after transmitting the uplink signal to the base station; starting a HARQ-RTT-timer after transmitting a physical uplink shared channel (PUSCH) signal; starting a HARQ-ReTX-timer after the HARQ-RTT-timer expires; and monitoring a physical downlink control channel (PDCCH) after the HARQ-ReTX-timer starts and before the first timer expires.

Example 16 may include the method of Example 13, further including: transmitting a signal to request the base station to enter an active duration of the DTX/DRX cycle.

Example 17 may include the method of any of Examples 1-9, wherein communicating with the base station within the time window includes: receiving a semi-persistent scheduling (SPS) signal over a physical downlink shared channel (PDSCH).

Example 18 may include the method of Example 17, wherein the SPS signal is received using a frequency resource based on an initial bandwidth part (BWP).

Example 19 may include the method of Example 17, wherein the SPS signal is received using a frequency resource based on one or more bandwidth parts (BWPs) that the base station uses in an active duration of the DTX/DRX cycle.

Example 20 may include the method of Example 17, further including: determining a configuration for retransmission; and controlling at least one timer based on the configuration for retransmission.

Example 21 may include the method of Example 20, further including: transmitting, to the base station, at least one of: a hybrid automatic repeat request (HARQ) acknowledgement (ACK), or a HARQ non-acknowledgement (NACK).

Example 22 may include the method of Example 20 or 21, wherein the configuration for retransmission indicates that retransmission of the uplink signal according to the CG is not allowed, and wherein controlling the at least one timer based on the configuration for retransmission includes: starting a first timer after receiving thea downlink signal from the base station; monitoring a physical downlink control channel (PDCCH) after the first timer starts and before the first timer expires; and keeping a HARQ-RTT-timer and a HARQ-ReTX-timer off.

Example 23 may include the method of Example 20 or 21, wherein the configuration for retransmission indicates that retransmission of the uplink signal according to the CG is not allowed, and wherein controlling the at least one timer based on the configuration for retransmission includes: starting a first timer after receiving thea downlink signal from the base station; starting a HARQ-RTT-timer after transmitting the HARQ non-acknowledgement (NACK); starting a HARQ-ReTX-timer after the HARQ-RTT-timer expires; and monitoring a physical downlink control channel (PDCCH) after the HARQ-ReTX-timer starts and before the first timer expires.

Example 24 may include the method of Example 20, further including: receiving an indication that the base station is about to enter an active duration of the DTX/DRX cycle.

Example 25 may include the method of Example 24, wherein the indication is received in at least one of: a radio resource control (RRC) signal, or a downlink control information (DCI) signal.

Example 26 may include the method of any of Examples 1-9, wherein communicating with the base station within the time window includes: monitoring a physical downlink control channel (PDCCH) for a dynamic scheduling signal.

Example 27 may include the method of any of Examples 1-26, wherein the base station is associated with a serving cell, and the configuration information is specific to the serving cell.

Example 28 includes a method performed by a user equipment (UE), the method including: determining that a base station enters a non-active duration of a discontinuous transmission or discontinuous reception (DTX/DRX) cycle from an active duration of the DTX/DRX cycle; and in response to the determining, applying a first logical channel (LCH) setting for communicating with the base station, wherein the first LCH setting is different from a second LCH setting that is applied when the base station is in the active duration of the DTX/DRX cycle.

Example 29 may include the method of Example 23, wherein the first LCH setting includes a first LCH prioritization (LCP) restriction that allows transmission according to a single configured grant (CG), and wherein the second LCH setting includes a second LCP restriction that allows transmissions according to a plurality of CGs.

Example 30 may include the method of Example 28, wherein the first LCH setting includes a first mapping from one or more LCHs to a single scheduling request (SR) resource, and wherein the second LCH setting includes a second mapping from the one or more LCHs to a plurality of SR resources.

Example 31 may include a non-transitory computer-readable medium storing program instructions that, when executed, cause a user equipment (UE) to perform the method of any of Examples 1-30.

Example 32 may include a user equipment (UE) including one or more processors configured to execute instructions that cause the UE to perform the method of any of Examples 1-30.

Example 33 may include one or more processors for a user equipment (UE), the one or more processors configured to execute instructions stored in memory coupled to the one or more processors to perform the operations of the method of any of Examples 1-30.

Example 34 includes a method performed by a base station, the method including: determining that the base station is in a non-active duration of a discontinuous transmission or discontinuous reception (DTX/DRX) cycle; and communicating with a user equipment (UE) within a time window corresponding to a particular communication occasion within the non-active duration, wherein the time window is determined by the UE based at least on the particular communication occasion and configuration information.

Example 35 may include the method of Example 34, further including performing discontinuous reception in the non-active duration of the DTX/DRX cycle, wherein the particular communication occasion includes a random access channel (RACH) occasion (RO).

Example 36 may include the method of Example 35, wherein the RO includes an associated physical uplink shared channel (PUSCH).

Example 37 may include the method of Example 34, further including performing discontinuous transmission in the non-active duration of the DTX/DRX cycle, wherein the particular communication occasion includes at least one of: a paging occasion (PO), a synchronization signal block (SSB) occasion, or a communication occasion of broadcasting a system information block (SIB).

Example 38 may include the method of any of Examples 34-37, further including transmitting, to the UE, a list of occasion configurations within the non-active duration.

Example 39 may include the method of Example 38, wherein the list of occasion configurations includes at least one of: a list of configured grant (CG) configurations, a list of semi-persistent scheduling (SPS) configurations, or a list of scheduling request (SR) configurations.

Example 40 may include the method of any of Examples 4-39, further including transmitting the configuration information to the UE.

Example 41 may include the method of any of Examples 34-40, wherein the configuration information includes a time mask, and wherein the particular communication occasion occurs at a time between a beginning and an end of the time mask.

Example 42 may include the method of any of Examples 34-41, wherein the configuration information includes at least one of a time offset measured from a starting time boundary of the particular communication occasion, or a time offset measured from an ending time boundary of the particular communication occasion.

Example 43 may include the method of any of Examples 34-42, wherein the configuration information indicates that the time window fully or partially overlaps the particular communication occasion.

Example 44 may include the method of any of Examples 34-43, wherein communicating with the UE within the time window includes at least one of: receiving, from the UE, a scheduling request (SR), or receiving, from the UE, an uplink signal according to a configured grant (CG).

Example 45 may include the method of Example 44, wherein communicating with the UE within the time window includes: receiving the SR using a frequency resource based on an initial bandwidth part (BWP).

Example 46 may include the method of Example 44, wherein communicating with the UE within the time window includes: receiving the SR using a frequency resource based on one or more bandwidth parts (BWPs) that the base station uses in an active duration of the DTX/DRX cycle.

Example 47 may include the method of Example 44, wherein communicating with the UE within the time window includes receiving the uplink signal according to the CG, the method further including: receiving one or more retransmissions from the UE.

Example 48 may include the method of Example 44, wherein communicating with the UE within the time window includes receiving the uplink signal according to the CG, the method further including: receiving, from the UE, a signal that requests the base station to enter an active duration of the DTX/DRX cycle.

Example 49 may include the method of any of Examples 34-43, wherein communicating with the UE within the time window includes: transmitting a semi-persistent scheduling (SPS) signal over a physical downlink shared channel (PDSCH).

Example 50 may include the method of Example 49, wherein the SPS signal is transmitted using a frequency resource based on an initial bandwidth part (BWP).

Example 51 may include the method of Example 49, wherein the SPS signal is transmitted using a frequency resource based on one or more bandwidth parts (BWPs) that the base station uses in an active duration of the DTX/DRX cycle.

Example 52 may include the method of Example 49, further including: determining a configuration for retransmission; and performing one or more retransmissions according to the configuration for retransmission.

Example 53 may include the method of Example 52, wherein the configuration for retransmission indicates to the UE that retransmission of the uplink signal according to the CG is not allowed, and wherein performing one or more retransmissions according to the configuration for retransmission includes: causing the UE to start a first timer after the UE transmitting the uplink signal to the base station; causing the UE to monitor a physical downlink control channel (PDCCH) after the first timer starts and before the first timer expires; and causing the UE to keep a HARQ-RTT-timer and a HARQ-ReTX-timer off.

Example 54 may include the method of Example 52, wherein the configuration for retransmission indicates to the UE that retransmission of the uplink signal according to the CG is allowed, and wherein performing one or more retransmissions according to the configuration for retransmission includes: causing the UE to start a first timer after the UE transmitting the uplink signal to the base station; causing the UE to start a HARQ-RTT-timer after the UE transmitting a physical uplink shared channel (PUSCH) signal; causing the UE to start a HARQ-ReTX-timer after the HARQ-RTT-timer expires; and causing the UE to monitor a physical downlink control channel (PDCCH) after the HARQ-ReTX starts and before the first timer expires.

Example 55 may include the method of Example 52, further including: receiving, from the UE, at least one of: a hybrid automatic repeat request (HARQ) acknowledgement (ACK), or a HARQ non-acknowledgement (NACK).

Example 56 may include the method of Example 52, further including: transmitting, to the UE, an indication that the base station is about to enter an active duration of the DTX/DRX cycle.

Example 57 may include the method of Example 56, wherein the indication is transmitted in at least one of: a radio resource control (RRC) signal, or a downlink control information (DCI) signal.

Example 58 may include the method of any of Examples 34-43, wherein communicating with the UE within the time window includes: transmitting a dynamic scheduling signal to the UE over a physical downlink control channel (PDCCH).

Example 59 may include the method of any of Examples 34-58, wherein the base station is associated with a serving cell, and the configuration information is specific to the serving cell.

Example 60 includes a method performed by a base station, the method including: communicating, in an active duration of a discontinuous transmission or discontinuous reception (DTX/DRX) cycle, with a user equipment (UE) according to a first logical channel (LCH) setting applied by the UE; entering a non-active duration of the DTX/DRX cycle; determining that the UE has switched to a second LCH setting that is different from the first LCH setting; and communicating, in the non-active duration of the DTX/DRX cycle, with the UE according to the second LCH setting.

Example 61 may include the method of Example 60, wherein the first LCH setting includes a first LCH prioritization (LCP) restriction that allows transmission according to a single configured grant (CG), and wherein the second LCH setting includes a second LCP restriction that allows transmissions according to a plurality of CGs.

Example 62 may include the method of Example 60, wherein the first LCH setting includes a first mapping from one or more LCHs to a single scheduling request (SR) resource, and wherein the second LCH setting includes a second mapping from the one or more LCHs to a plurality of SR resources.

Example 63 may include a base station including one or more processors configured to execute instructions that cause the base station to perform the method of any of Examples 34-62.

Example 64 may include a non-transitory computer-readable medium storing program instructions that, when executed, cause a base station to perform the method of any of Examples 34-62.

Example 65 may include one or more non-transitory computer-readable media including instructions to cause an electronic device, upon execution of the instructions by one or more processors of the electronic device, to perform one or more elements of a method described in or related to any of the above-described examples, or any other method or process described herein.

Example 66 may include an apparatus including logic, modules, or circuitry to perform one or more elements of a method described in or related to any of the above-described examples, or any other method or process described herein.

Example 67 may include a method, technique, or process as described in or related to any of the above-described examples, or portions or parts thereof.

Example 68 may include an apparatus including: one or more processors and one or more computer-readable media including instructions that, when executed by the one or more processors, cause the one or more processors to perform the method, techniques, or process as described in or related to any of the above-described examples, or portions thereof.

Example 69 may include a signal as described in or related to any of the above-described examples, or portions or parts thereof.

Example 70 may include a datagram, information element, packet, frame, segment, PDU, or message as described in or related to any of the above-described examples, or portions or parts thereof, or otherwise described in the present disclosure.

Example 71 may include a signal encoded with data as described in or related to any of the above-described examples, or portions or parts thereof, or otherwise described in the present disclosure.

Example 72 may include a signal encoded with a datagram, IE, packet, frame, segment, PDU, or message as described in or related to any of the above-described examples, or portions or parts thereof, or otherwise described in the present disclosure.

Example 73 may include an electromagnetic signal carrying computer-readable instructions, wherein execution of the computer-readable instructions by one or more processors is to cause the one or more processors to perform the method, techniques, or process as described in or related to any of the above-described examples, or portions thereof.

Example 74 may include a computer program including instructions, wherein execution of the program by a processing element is to cause the processing element to carry out the method, techniques, or process as described in or related to any of the above-described examples, or portions thereof. The operations or actions performed by the instructions executed by the processing element can include the methods of any of the above-described examples.

Example 75 may include a signal in a wireless network as shown and described herein.

Example 76 may include a method of communicating in a wireless network as shown and described herein.

Example 77 may include a system for providing wireless communication as shown and described herein. The operations or actions performed by the system can include the methods of any of the above-described examples.

Example 78 may include a device for providing wireless communication as shown and described herein. The operations or actions performed by the device can include the methods of any of the above-described examples.

The previously-described examples are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any of the above-described examples.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-64. (canceled)

65. A method comprising:
determining that a base station is in a non-active duration of a discontinuous transmission (DTX) or discontinuous reception (DRX) cycle;
determining a communication occasion within the non-active duration of the DTX or DRX cycle;
determining a time window that overlaps with at least a portion of the communication occasion within the non-active duration of the DTX or DRX cycle based at least on configuration information; and
communicating with the base station during the time window.

66. The method of claim 65, wherein:
the base station performs discontinuous reception in the non-active duration of the DTX or DRX cycle, and
the communication occasion comprises a random access channel (RACH) occasion (RO).

67. The method of claim 66, wherein the RO comprises an associated physical uplink shared channel (PUSCH).

68. The method of claim 65, wherein:
the base station performs discontinuous transmission in the non-active duration of the DTX or DRX cycle, and
the communication occasion comprises at least one of:
a paging occasion (PO),
a synchronization signal block (SSB) occasion, or
a system information block (SIB) broadcast occasion.

69. The method of claim 65, wherein determining the communication occasion within the non-active duration comprises:
receiving, from the base station, a list of occasion configurations within the non-active duration; and
determining the communication occasion from the list.

70. The method of claim 69, wherein the list of occasion configurations comprises at least one of:
a list of configured grant (CG) configurations,
a list of semi-persistent scheduling (SPS) configurations, or
a list of scheduling request (SR) configurations.

71. The method of claim 65, wherein communicating with the base station during the time window comprises at least one of:
transmitting a scheduling request (SR),
or transmitting an uplink signal according to a configured grant (CG).

72. The method of claim 71, wherein communicating with the base station during the time window comprises:
transmitting the SR or the uplink signal using a frequency resource based on an initial bandwidth part (BWP).

73. The method of claim 71, wherein communicating with the base station during the time window comprises:
transmitting the SR or the uplink signal using a frequency resource based on one or more bandwidth parts (BWPs) that the base station uses in an active duration of the DTX or DRX cycle.

74. The method of claim 71, wherein communicating with the base station during the time window comprises transmitting the uplink signal according to the CG, the method further comprising:
determining a configuration for retransmission; and
controlling at least one timer based on the configuration for retransmission.

75. The method of claim 74,
wherein the configuration for retransmission indicates that retransmission of the uplink signal according to the CG is not allowed, and
wherein controlling the at least one timer based on the configuration for retransmission comprises:
starting a first timer after transmitting the uplink signal to the base station;
monitoring a physical downlink control channel (PDCCH) after the first timer starts and before the first timer expires; and
keeping a HARQ-RTT-timer and a HARQ-ReTX-timer off.

76. The method of claim 74,
wherein the configuration for retransmission indicates that retransmission of the uplink signal according to the CG is allowed, and
wherein controlling the at least one timer based on the configuration for retransmission comprises:
starting a first timer after transmitting the uplink signal to the base station;
starting a HARQ-RTT-timer after transmitting a physical uplink shared channel (PUSCH) signal;
starting a HARQ-ReTX-timer after the HARQ-RTT-timer expires; and
monitoring a physical downlink control channel (PDCCH) after the HARQ-ReTX-timer starts and before the first timer expires.

77. The method of claim 74, further comprising:
transmitting a signal to request the base station to enter an active duration of the DTX or DRX cycle.

78. The method of claim 65, wherein communicating with the base station during the time window comprises:
receiving a semi-persistent scheduling (SPS) signal over a physical downlink shared channel (PDSCH).

79. The method of claim 78, wherein the SPS signal is received using a frequency resource based on an initial bandwidth part (BWP).

80. A method comprising:
determining that a base station is in a non-active duration of a DTX or DRX cycle; and
communicating with a user equipment (UE) during a time window that overlaps with at least a portion of a communication occasion within the non-active duration of the DTX or DRX cycle of the base station, wherein the time window is determined based at least on the communication occasion and configuration information.

81. The method of claim 80, wherein the configuration information comprises a time mask, and wherein the communication occasion occurs between a beginning and an end of the time mask.

82. The method of claim 80, wherein the configuration information comprises at least one of a time offset measured from a starting time boundary of the communication occasion, or a time offset measured from an ending time boundary of the communication occasion.

83. The method of claim 80, wherein the configuration information indicates that the time window fully or partially overlaps with the communication occasion.

84. An apparatus comprising:
one or more processors; and
memory storing instructions that, when executed by the one or more processors, cause the apparatus to perform operations comprising:
determining that a base station is in a non-active duration of a DTX or DRX cycle;
determining a communication occasion within the non-active duration of the DTX or DRX cycle;
determining a time window that overlaps with at least a portion of the communication occasion within the non-active duration of the DTX or DRX cycle based at least on configuration information; and
communicating with the base station during the time window.
